(19) United States
(12) Patent Application Publication
(10) Pub. No.: US 2007/0137761 A1
(43) Pub. Date: Jun. 21, 2007

(54) Drywall taping tool

(75) Inventor: Richard Scaletta, Valley View, OH (US)

Correspondence Address: Deron A. Cook;Brouse McDowell , LPA, Ste. 500, 388 S. Main Street, Akron, OH, 44311-4407, US

(73) Assignee: SIGNATURE INTERIORS, INC.

(21) Appl. No.: 11/314,259

(22) Filed: Dec. 21, 2005

(51) Int. Cl. E04F 13/00; B65C 11/04; B65H 35/06

(52) U.S. Cl. 156/71; 156/578; 225/42

(57) ABSTRACT

What is taught is a drywall tape dispenser, comprising a frame suitably sized to fit substantially inside a standard five-gallon container. The frame includes first and second parallel frame sides, which may have a maximum length of 14 inches and a maximum height of 18 inches. The frame further includes at least a first frame edge connecting the first and second frame sides, the first frame edge may have a width of between approximately 2 inches and 3 inches. The device additionally includes an axle adapted to receive a roll of drywall tape, a guide rod received by the first and second frame sides positioned below the axle, a guide slot located adjacent the first side frame edge, the guide slot adapted to guide a length of drywall tape in a substantially vertical direction, and a trimmer located downstream of the guide slot.

### I. BACKGROUND OF THE INVENTION

A. Field of Invention

This invention pertains to the art of methods and apparatuses of drywall installation and more particularly, to devices for applying joint compounded drywall tape to an associated wall.

B. Description of the Related Art

Drywall installation involves affixing sheets of drywall, also known as gypsum board, to metal or wood studs, joists, and rafters and covering the seams with drywall tape. Taping the seams is an essential step in ensuring a smooth wall as cracks will develop along unfinished or poorly taped seams. To tape the seams, drywall tape, typically two-inch wide heavy paper, is pasted to the drywall astride the seams. Joint compound, also known as mud, or drywall compound, serves as the paste into which the tape is pressed to hold it to the wall.

Drywall taping traditionally involves the steps of putting joint compound into the seam, cutting a length of drywall tape sufficient to cover the seam, laying the tape in the compound, smoothing out air pockets and putting additional joint compound over the tape to cover and flatten the joint.

To speed the process of drywall taping, devices have been created that to deposit joint compound directly onto the tape so that the initial step of putting compound into the seam can be eliminated. Such devices typically involve drawing drywall tape from a roll through a reservoir of joint compound. As the tape passes through the reservoir, joint compound is deposited onto the surfaces of the tape. The compounded tape can then be cut and put on the seam. Existing devices, however, have several shortcomings that are addressed in the present invention. For example, the device disclosed in U.S. Pat. No. 5,736,001, contains a very small reservoir for joint compound. As a result, the reservoir needs to be refilled repeatedly, which reduces speed and interrupts workflow. Moreover, to thread the tape of a new tape roll through the unit requires dumping the compound out of the reservoir or otherwise making a substantial mess trying to thread the tape through the filled reservoir.

U.S. Pat. Nos. 5,676,793, 5,242,495 and 4,757,783 disclose devices that are used in conjunction with large containers of joint compound, though in each case, the container has to be specially modified to use with the frame bearing the drywall tape roll. These modifications either require specialty containers or render standard containers largely useless for other purposes. Particularly problematic is the modification to allow the tape to exit through an opening in the container side-wall near the bottom of the container. Such an opening permits significant amounts of joint compound to exit the container onto the floor, which creates a potentially dangerous mess and wastes joint compound. Furthermore, to thread these devices requires emptying the container of joint compound so that the tape can be threaded through the bottom opening of the container. Additionally, because the tape exits horizontally adjacent the bottom of the container, the user must constantly bend down to grab the tape and, in pulling the tape upward toward the top of the wall, the top edge of the tape rubs against the top edge of the opening, thereby scraping the joint compound off one side of the tape.

Finally, U.S. Pat. No. 4,996,941 discloses a device that sits a top a container containing joint compound. The height of the device interferes with a top located container handle. Moreover, the rollers need to be cleaned routinely to keep them operating smoothly.

It is desirable therefore to provide a device for depositing joint compound onto drywall tape that is relatively simple to operate and easy to thread. It is desirable to provide a device that can be used with standard, widely available multi-gallon containers, including joint compound containers, which are widely available and provide a large reservoir for joint compound. It is further desirable to provide a device that operates without requiring modifications to the associated containers. It is desirable to provide a device that can be threaded without having to empty the container and wherein the tape exits the top of the container so that joint compound stays in the container, rather than leaking onto the floor through a hole in the side-wall. It is desirable to provide a device that fits substantially within or entirely within the container so as not to interfere with the handle of the container or even the lid of the container, which makes moving the container and device simpler and safer. It is desirable to provide a device that can hold a 500-foot roll of drywall tape. It is desirable to provide a device that allows the user to draw tape from the device in a substantially vertical direction, from near the top of the device so that the user does not have to bend over very far and so that the joint compound is not scraped off the tape before it can be put onto the wall. It is additionally desirable to provide a device that has a built in trimmer to cut the tape to length. It is further desirable to provide a device that is corrosion resistant and easy to clean.

The present invention provides a device that addresses and embodies all of these desirable features. What is taught is a drywall tape dispenser, comprising a frame that fits entirely inside a standard multi-gallon bucket. The frame includes first and second parallel frame sides. The first and second frame sides may have a maximum length of 14 inches and a maximum height of 18 inches so as to fit neatly within a standard five-gallon bucket container. The frame may further include at least a first frame edge connecting the first and second frame sides. The first frame edge may have a width of between approximately 2 inches and 3 inches to allow ample room between the first and second frame sides for a roll of drywall tape. The device additionally includes an axle adapted to receive a roll of drywall tape, a guide rod received by the first and second frame sides positioned below the axle, a guide slot located adjacent the first side frame edge, the guide slot adapted to guide a length of drywall tape in a substantially vertical direction, and a trimmer located downstream of the guide slot.

### II. SUMMARY OF THE INVENTION

According to one aspect of the present invention, a new and improved drywall tape compounding device is provided that operates in conjunction with a standard multi-gallon container. According to another aspect of the invention, the device operates in conjunction with a standard five-gallon container.

According to another aspect of the invention, the device sits neatly within the container.

According to still another aspect of the invention, the device can be used with a standard container without requiring modifications to the container.

According to yet another aspect of the invention, the device includes a rugged frame suitable for holding up to a 500 foot roll of drywall tape.

According to another aspect of the invention, the device provides for joint compound to be deposited onto the surfaces of drywall tape.

According to still another aspect of the invention, the device includes a built in trimmer.

According to another aspect of the invention, the device allows the user to draw compounded tape from the frame in a substantially vertical direction.

According to yet another aspect of the invention, the device allows the user to draw compounded tape from the top of the container.

According to still another aspect of the invention, the device can be removed from the joint compound to replace the roll of drywall tape so the compound can remain in the container.

According to yet another aspect of the invention, the device can be easily removed from the joint compound to thread the tape so that the tape does not need to be threaded through the reservoir of joint compound.

According to another aspect of the invention, the device is corrosion resistant and can be stored in the container containing joint compound.

According to another aspect of the invention, the device is easily cleaned.

According to still another aspect of the invention, the device has no moving parts that need to be maintained.

According to another aspect of the invention, the device does not interfere with the container handle.

According to another aspect of the invention, the device resists tipping, being substantially inside the container.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a plan view of the device shown from the side, in an associated bucket.

FIG. 2 is a plan view of the device.

FIG. 3 is a close-up view showing the guide slot and guide rod.

FIG. 4 is a close-up view showing the tape threaded through the guide slot.

FIG. 5 depicts an alternative frame base configuration.

FIG. 6 is an alternate view of the device show in FIG. 1.

FIG. 7 depicts application of joint compounded tape.

### IV. DESCRIPTION OF THE PREFERRED EMBODIMENT

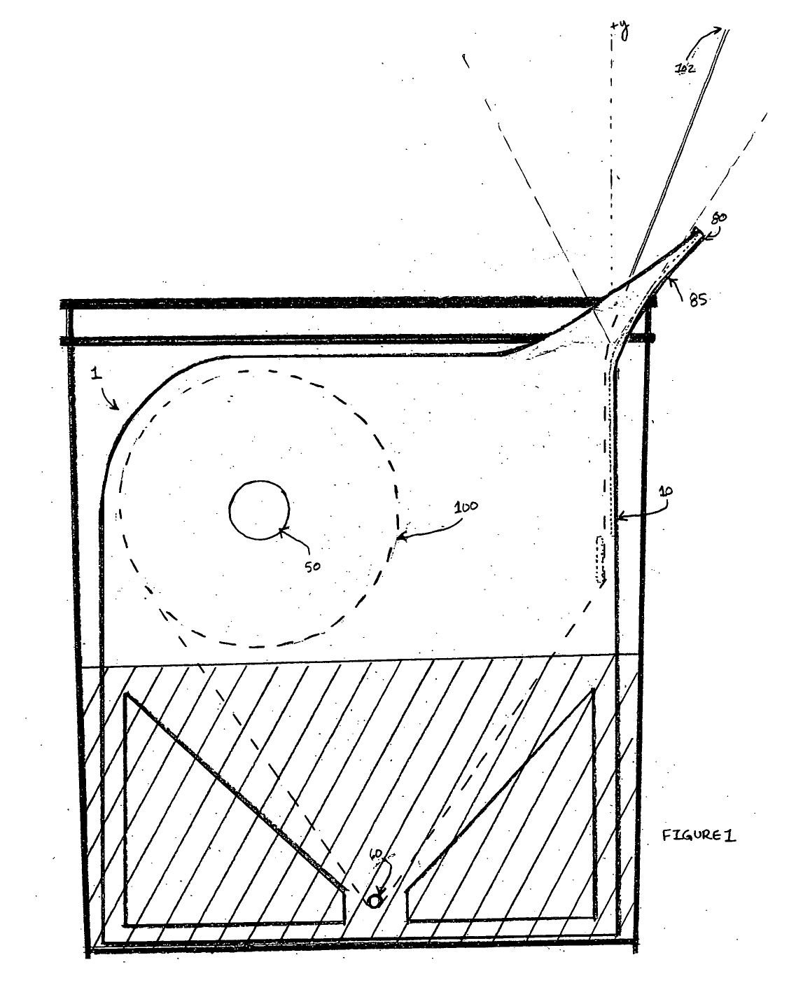

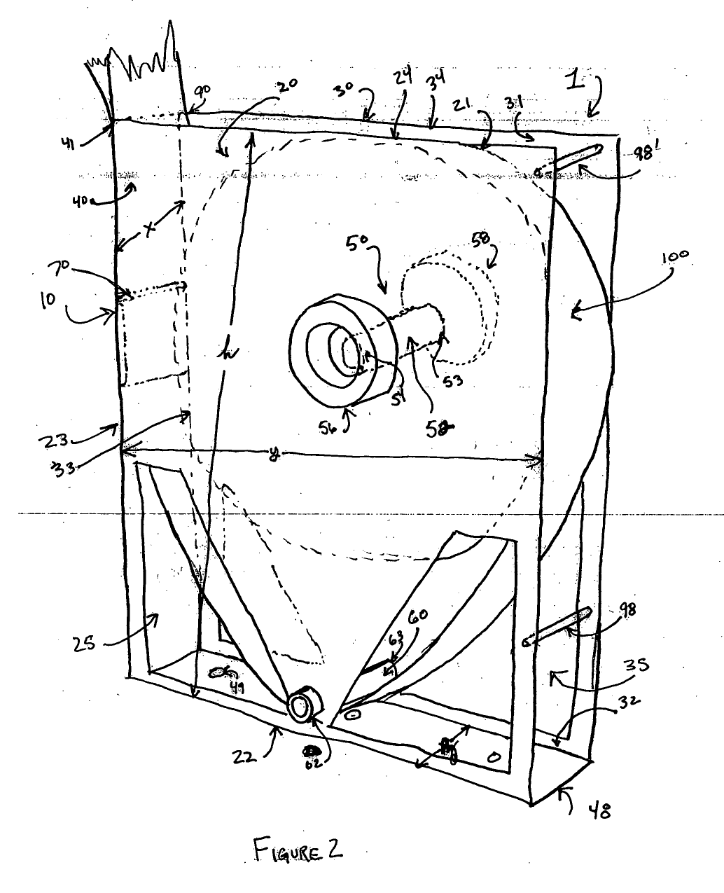

Referring now to the drawings wherein the showings are for purposes of illustrating a preferred embodiment of the invention only and not for purposes of limiting the same, FIGS. 1-2 show a drywall tape dispensing device or device 1. The device 1 may include a frame 10, an axle 50, a guide rod 60, a guide slot 70, and a trimmer 80. As will be discussed in further detail below, the frame 10 may be adapted to receive the axle 50. A roll of drywall tape 100 may be rotatably received onto the axle 50. The device 1 may be placed into a bucket containing drywall compound. The free end 102 of the drywall tape roll 100 may be threaded past the guide rod 60, through the guide slot 70. As the end of the drywall tape 102 passes through the guide slot 70 it may be traveling in a substantially vertical direction. The depth of drywall compound in the bucket may extend at least to the bottom of the guide rod 60 so that as the drywall tape passes the guide rod 60 at least a first surface of the drywall tape is coated with joint compound. A length of drywall tape may be drawn from the drywall tape roll 100, past the roller guide 60, through the guide slot 70. When an appropriate length of drywall tape has been drawn from the drywall tape roll 100, the length may be cut with the trimmer 80.

With reference to FIGS. 1-4, the device 1 will be described in further detail. The frame 10 may include first and second frame sides 20, 30 and at least a first frame edge 40. Each of the first and second frame sides 20, 30 may have an inside face 21, 31, a bottom edge 22, 32 and at least a first side edge 23, 33. The first and second frame sides 20, 30 may be joined at their respective bottom edges 22, 32 to a frame base 48. In a similar matter, the first and second frame sides 20, 30 may be joined at their respective first side edges 22, 33 to the first frame edge 40. The first and second frame sides 23, 33 may be substantially parallel to each other, separated by a distance x of between approximately 2 inches and approximately 3 inches, which may be the same as the width of the first frame edge 40. It is noted that the frame base 48 may serve to stabilize the device 1 and aid in preventing tipping during operation. The frame base 48 may also serve to assist in maintaining the parallel configuration of the first and second frame sides 20, 30. It is recognized that this latter function may be performed by a variety of other means, such as a second frame edge (not shown), or a plurality of rigid posts 98, 98′ extending between the first and second frame sides 20, 30. The embodiment depicted in FIG. 2 shows a frame 10 that includes a frame base 48 suitable for assisting in maintaining the first and second frame sides 20, 30 in a parallel configuration.

With continued reference to FIG. 1, the first and second frame sides 20, 30, frame base 48, and at least a first frame edge 40 may be integrally joined, being formed as a single piece. In an alternative embodiment, the first and second frame sides 20, 30, frame base 48, and at least a first frame edge 40 may be separate pieces attached together to form the frame 10. These components may be fixedly attached to each other, such as by welding, gluing, solvent welding, or through the use of fasteners, such as rivets, though any other means of fixedly attaching the frame sides 20, 30, frame base 48 and first frame edge 40 together may be selected with sound engineering judgment. Alternatively, the frame sides 20, 30, frame base 48, and first frame edge 40 may be removably attached to each other, such as with sliding dovetails or clips that are received into corresponding slots. In this way, the frame 10 may be disassembled for shipping or for cleaning.

Any rigid material may be selected for the frame sides 20, 30, frame base 48, and frame edge 40, including plastic, stainless steel, and aluminum. It is contemplated that the frame 10 may be in substantial contact with joint compound. Therefore, the materials selected for the frame 10 may be non-corrosive with respect to joint compound. Alternatively, the materials selected for the frame 10 may be treated chemically or with film to prevent corrosion.

As noted above, and as shown in FIG. 1, it is anticipated that in one embodiment, the frame 10 may fit substantially within a container suitable for holding joint compound, which may be referred to as a joint compound reservoir. By “substantially within” it is meant that the frame 10 may sit inside the container to a depth of at least one half of the shortest of the two frame sides 20, 30. In an alternative embodiment, the frame 10 may sit entirely within a joint compound reservoir, while other components, such as an extension arm 85 and trimmer 80 (discussed below) may extend outside the container. In yet another embodiment, the entire device 1 may sit entirely within a joint compound reservoir.

The frame 10 may be adapted to fit within any size container; however, joint compound is typically sold in one-gallon or five-gallon round containers. For economic reasons and efficiency, the purchase and use of five-gallon containers of joint compound is often preferable over one-gallon containers, particularly with drywall professionals. Joint compound is often used straight out of the container it is purchased in or it may be transferred to a different container, which may be another five-gallon container. While there are a wide variety of five-gallon containers, including five-gallon joint compound containers, most are substantially round, plastic or metal containers having a diameter of between 10 and 12 inches and a height of between 12 and 18 inches. These containers may be adapted to receive a lid that fits securely to prevent spillage. Furthermore, they may include a handle to aid in transporting the container. The handle may be an inverted U-shaped handle that is attached to the upper container lip. It should be understood that the scope of this patent is not directed to a particular container, and thus, any container suitable for holding joint compound and suitably large to substantially receive the frame 10, may be used in accordance with the present invention; however, it is contemplated that the specific device 1 may be used in conjunction with any five-gallon container having a bottom inside diameter of between approximately 10 inches and 12 inches and a height of between 12 inches and 18 inches. Such a container is referred to herein as a “standard five-gallon container”. Five-gallon containers in which joint compound is sold are referred to as “standard five-gallon joint compound containers”. For purposes of this description, the term “standard five gallon container” includes standard five-gallon joint compound containers.

With continued reference to FIGS. 1 and 2, the first and second frame sides 20, 30 may be substantially the same size. The width Y of the first and second frame sides 20, 30, which may be referred to as the length of the frame 10, may be between approximately 8 inches and approximately 11.75 inches, preferably between 9 inches and 11 inches. The height H of the first and second frame sides 20, 30 may be between approximately 8 inches and approximately 18 inches, preferably between 10 inches and 12 inches. The first and second frame sides 20, 30 may be held parallel to each other, such as by means of the frame base 48 and the at least a first frame edge 40. As discussed above, the first and second frame sides 20, 30 may be held in a parallel configuration by a variety of means. The first and second frame sides 20, 30 may be substantially rectangular.

With reference to FIG. 2, the frame base 48 may also be substantially rectangular, having a width Z of between approximately 2 inches and approximately 3 inches. The length of the frame base 48 may be approximately equal to the width Y of the first and second frame sides 20, 30 at their respective bottom edges 22, 32. Alternatively to prevent tipping of the device 1 or to provide greater surface area for the base of the device 1, the frame base 48 may have a width Z greater than 3 inches or a length greater than the width Y of the bottom edges 22, 32 of the first and second frame sides 20, 30. To allow the frame 10 to fit substantially within a standard five-gallon container, the frame base 48 should preferably not have a width or length that is greater than the inside diameter of the container at the inside bottom of the container.

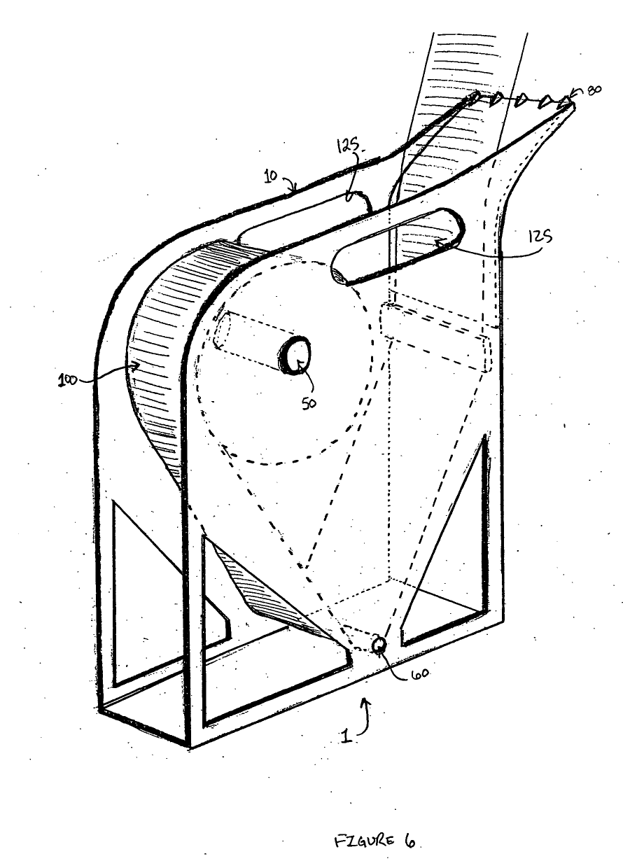

With reference to FIG. 5, it should be noted that the frame base 48 need not be a solid member to aid in maintaining the first and second frame sides 20, 30 in a substantially parallel arrangement. Thus, the frame 48 base could consist of at least one or a plurality of cross members extending between the first and second frame sides 20, 30 adjacent their respective bottom edges. It should also be noted, that the frame base 48 need not extend between the first and second frame sides 20, 30 in order to assist in holding the first and second frame sides 20, 30 in a parallel configuration.

The frame base 48 may include at least a first drain hole 49 to allow joint compound to drain from the interior of the frame 10 and to enable the frame base 48 more easily to pass through the joint compound.

The first frame edge 40 may extend between the first and second frame sides 20, 30. The first frame edge 40 may extend the entire height H of the first and second frame sides 20, 30. As shown in FIG. 2, however, the first frame edge 40 may only partially extend the height H of the first and second frame sides 20, 30. The width X of the frame edge 40 may be between approximately 2 inches and approximately 3 inches. As discussed in further detail below, the first frame edge 40 may be adapted to serve as the guide slot 70. Also as discussed below the trimmer 80 may be located adjacent the upper end 41 of the first side edge 40.

With continued reference to FIGS. 1-2, the device 1 may include an axle 50 operatively connected to at least one of the first and second frame sides 20, 30 by any means selected with sound engineering judgment. The purpose of the axle 50 is to suspend a drywall tape roll 100 so that the drywall tape roll 100 may rotate as tape is drawn from the roll 100. The term “axle” includes any protrusion that extends from the inside face 21, 31 of at least one of the first or second frame sides 20, 30 into the hollow core of a drywall tape roll 100. The term “axle” also includes any assembly having a shaft that extends between the first and second frame sides 20, 30 and passes through the hollow core of a drywall tape roll 100. The axle 50 may be removably operatively connected to at least one of the first and second frame sides 20, 30. The axle 50 may be, but need not be operatively connected to at least one of the first and second frame sides 20, 30.

In one embodiment, shown in FIG. 2, the axle 50 may include a shaft 52 having a first and second ends 53, 54, which may be threaded, and first and second retaining rings 56, 58 adapted to be threaded onto the first and second axle ends 53, 54. The axle shaft 50 may extend through an axle shaft hole (not shown) provided in each of the first and second frame sides 20, 30, so that the first and second axle ends 53, 54 extend outside the first and second frame sides 20, 30. The first and second axle retaining rings 56, 58 may be threaded onto the first and second axle ends 53, 54. The first and second axle retaining rings 56, 58 may have a diameter greater than the diameter of the axle shaft holes so that the retaining rings will not pull through the axle shaft holes. The axle shaft 50 may be removed from the frame 10 by removing one of the retaining rings 56, 58 and then pulling the axle shaft 50 through the axle shaft holes. The diameter of the axle shaft 50 should be sufficiently large to impart rigidness to the shaft 50 under the weight of a full drywall tape roll 100, but not greater than the inside diameter of the hollow core of the drywall tape roll 100.

In an alternative embodiment, not shown in the FIGURES, the axle 50 may include two protrusions, one extending from each of the inside faces 21, 31 of the first and second frame sides 20, 30, the protrusions being sufficiently long to extend into the hollow core of the drywall tape roll 100 and suspend the drywall tape roll 100 securely. In yet another embodiment, two substantially U-shaped protrusions may extend from the inside face of the first and second frame sides. The substantially U-shaped protrusions may be adapted to receive and suspend a shaft having a length that is less than the width X of the frame 10. The shaft 50 may rest in the substantially U-shaped protrusions thereby suspending the drywall tape roll 100 between the first and second frame sides 20, 30.

With continued reference to FIGS. 1-3, the device 1 may further include a guide rod 60 operatively connected to at least one of the first and second frame sides 20, 30 by any means selected with sound engineering judgment. The guide rod 60 may be located between the frame base 48 and the axle 50, but sufficiently above the frame base 48 to allow space for the drywall tape to pass between the guide rod 60 and the frame base 48. The guide rod 60 may extend between the first and second frame sides 20, 30. The guide rod 60 may be a solid or hollow tube having first and second ends 62, 63 and a substantially arcuate outer surface. In one embodiment, the guide rod 60 may be operatively connected to the first and second frame sides 20, 30 by guide rod holes (not shown) provided in each of the first and second frame sides 20, 30 through which the guide rod 60 may extend. In an alternate embodiment, the first and second ends 62, 63 of the guide rod 60 may be affixed to the inside faces 21, 31 of the first and second frame sides20, 30, such as by mechanical means, including welding. In yet another embodiment, the guide rod 60 may be integrally formed with the first and second frame sides 20, 30. The guide rod 60 may be rotatably operatively connected to at least on of the first and second frame sides 20, 30. The guide rod 60 may be fixedly attached or removably attached thereto.

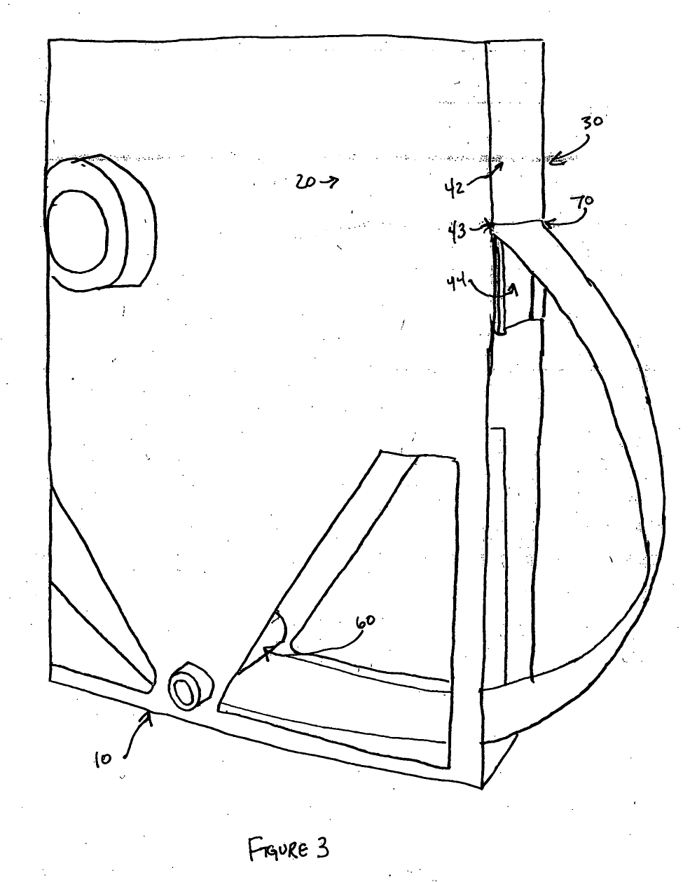

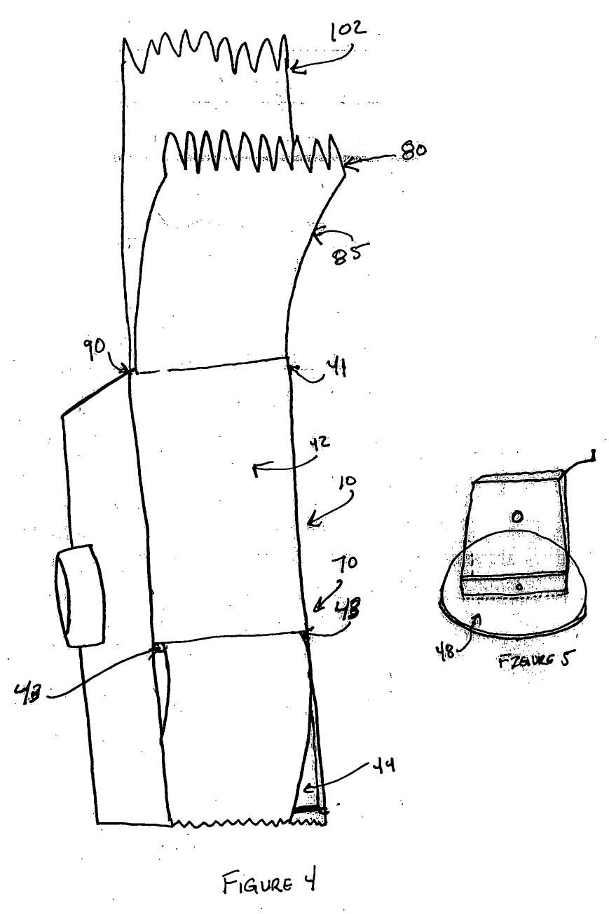

With continued reference to FIGS. 3-4, the device 1 may further include a guide slot 70. The guide slot 70 may be located adjacent the first frame edge 40. The guide slot 70 may be integral with the first frame edge 40. The guide slot 70 may serve to guide the drywall tape into a substantially vertical direction, preferably until the tape exits the frame 10 (shown in FIG. 1). This will be described in greater detail below. In the embodiment shown in FIGS. 3-4, the guide slot 70 may be integral with the first frame edge 40. More specifically, the first frame edge 40 may include an upper portion 42 and a lower portion 44, separated by a gap 43 extending substantially the width X of the first frame edge 40, the gap being sufficiently large to permit drywall tape to pass through it. The lower portion 44 of the first frame edge 40 may be depressed into the interior of the frame 10 so as to expand the gap 43 between the upper and lower portions 42, 44 and permit the joint compounded drywall tape to pass between the upper and lower portions 42, 44. It is noted that this embodiment allows the drywall tape to exit the frame, traveling in a substantially vertical direction (FIG. 1).

In an embodiment not shown, a plurality of directional roller bearings could be used to guide the joint compounded tape into a vertical traveling direction in place of a guide slot 70. The directional roller bearings could include tubes, similar to the guide rod 60, fixed between the first and second frame sides 20, 30 in a pattern defining a space through which the joint compounded tape can pass. It should be noted that the drywall tape needs to be threaded through the frame 10. Therefore, it is preferable that the guide slot 70 be easy to thread.

A variety of other means may be employed to direct the drywall tape into a substantially vertical direction, including variations on guide slots and directional roller bearings. In saying that the guide slot 70 directs the drywall tape into a substantially vertical direction, it is meant that the guide slot 70 directs the direction of travel of the drywall tape drawn from the roll to between positive and negative 30 degrees, and preferably between positive and negative 15 degrees, of the positive vertical axis, as shown in FIG. 1.

With continued reference to FIGS. 1 and 4, the device 1 may include a trimmer 80 to cut the drywall tape to length. The trimmer 80 may be located immediately adjacent the exit point 90 of the frame 10, which is the point at which the drywall tape exits the frame 10. The trimmer 80 may be located downstream of the guide slot 70, meaning the drywall tape passes through the guide slot 70 before reaching the trimmer 80. In the embodiment shown in FIGS. 1 and 4, the exit point 90 is at the top of the first frame edge 40. The trimmer 80 may be a sharp or serrated edge that cuts the drywall tape when the tape is pressed against it. The trimmer 80 could, alternatively be a guillotine type device, having a sharp blade that is pressed downward to slice the drywall tape. Alternatively the trimmer 80 could resemble a standard paper cutter, having a blade that is hingedly attached at one end to the first or second frame side 20, 30 or the first frame edge 40 and is drawn to slice the tape. Any other means for trimming the tape may be selected with sound engineering judgment.

Placing the trimmer 80 immediately adjacent the exit point 90 may not be preferable in some applications because the tape may get accidentally or unintentionally cut as it is being drawn out of the frame 10. Accordingly, as shown in FIG. 1, it may be advantageous to provide an extension arm 85 between the exit point 90 and the trimmer 80. In this way, the trimmer 80 may be positioned out of the immediate path of the tape and accidental cuts can be avoided. As shown in FIG. 4, the trimmer 80 may be integral with the extension arm 85. Furthermore, the extension arm 85 may be integral with the upper portion 42 of the firs frame edge 40.

With reference to FIGS. 1-2, the arrangement of the axle 50, guide rod 60, and guide slot 70 will now be described. A principal object of the device 1 is to feed drywall tape from a roll 100, through joint compound, wherein a layer of joint compound can be deposited onto a first surface of the tape, and then out the frame 10 at the exit point 90 traveling in a substantially vertical direction. The axle 50 is the component of the device 1 upon which the drywall tape roll 100 may be mounted. The guide rod 60 serves to restrain the tape in the joint compound located in the bottom of the container. The guide slot 70 serves to direct the joint compounded tape into a substantially vertical direction of travel. It is noted that other functions may be served by these components.

The direction that drywall tape travels through the device 1 is best illustrated in FIG. 2. The free end 102 of the roll of drywall tape 100 mounted on the axle 50 is fed downward toward and underneath the guide rod 60 and then upward through the guide slot 70 where it is directed substantially vertically through to the exit point 90. The axle 50, guide rod 60 and guide slot 70 thusly form a V, wherein the nadir of the V is the guide rod 60 and wherein the guide rod 60 is below the axle 50 and the guide slot 70. The guide rod 60 may additionally be located between the axle 50 and the guide slot 70. By “between” it is meant that the vertical plane running perpendicular to the first and second frame sides 20, 30 at the axis of the guide rod 60 is between the vertical planes running perpendicular to the first and second frame sides 20, 30 located at the axis of the axle 50 and at the guide slot 70 respectively.

In accordance with the embodiment shown in FIG. 1, the longitudinal axis of the axle 50 may be centered between approximately 3 inches and 8 inches from the first side edges 23, 33 of the first and second frame sides 20, 30 respectively, and preferably between 4 and 6 inches, and between approximately 2 inches and 6 inches from the top edge 24, 34 of the first and second frame sides 20, 30, preferably between 3 and 5 inches. It is preferable, but not essential that the axle 50 be positioned so that the drywall tape roll 100 does not extend past the frame 10 and prevent the frame from sitting substantially within the container.

The longitudinal axis of the guide rod 60 may be centered between approximately 2 inches and 8 inches from the first side edges 23, 33 of the first and second frame sides 20, 30 respectively, preferably between 4 inches and 6 inches, and between approximately ¼ and 1.5 inches from the bottom edge 22, 32 of the first and second frame sides 20, 30. There should be sufficient space between the guide rod 60 and the frame base 48 or container bottom, if there is no frame base, to allow the tape to pass between them without rubbing the frame base 48 or container bottom. The lower the guide rod 60 is positioned, the longer the device 1 can be used without having to refill the container with joint compound. Thus, while it is possible to center the guide rod 60 more than 1.5 inches above the bottom edge 22, 32 of the first and second frame sides 20, 30, the bottom of the guide rod 60 must be below the level of joint compound in the bucket in order to ensure that the tape is appropriately layered with compound.

With reference now to FIGS. 1, 2 and 7, the operation of the device 1 will now be described. After the drywall tape roll 100 is loaded into the axle 50, the free end 102 of the tape roll 100 may be threaded past the guide rod 60 and through the guide slot 70 to the exit point 90. The device 1 may be placed substantially within a container. As discussed above, the container may be a standard five gallon container. The container may already have joint compound in it. Alternatively, joint compound may be poured into the container. The level of joint compound should extend at least above the bottom of the guide rod 60. It is preferable, but not essential that the level of joint compound not extend above the axle 50. To enable the joint compound to get into the interior of the frame 10, one or more panel openings 25, 35 may be provided in the lower portion of the first and second frame sides 20, 30. Additionally or alternatively, drain holes 49 may be provided in the frame base 48.

With continued reference to FIGS. 1, 2, and 7, the container may be moved adjacent a wall to be taped, such as with the handle on the bucket. The free end 102 of the tape may be grasped and pulled substantially upward toward the top of the wall. As the tape is drawn upward, tape is pulled from the roll downward into the joint compound wherein a layer of joint compound is deposited on the surfaces of the tape. The tape passes beneath the guide rod 60 toward the guide slot 70. As the tape approaches the guide slot 70, it will have been coated in joint compound. The joint compounded tape enters the guide slot 70 and is directed in a substantially vertical direction by the guide slot 70. It is beneficial if the guide slot 70 allows sufficient space between the gap 43 and the joint compounded tape to prevent the edges of the gap 43 from scraping the joint compound from at least the bottom face of the tape, which may be the face placed against the wall. However, the tape may be drawn over the bottom edge of the gap in order to substantially remove the joint compound from the top of the face tape. By directing the tape into a substantially vertical direction, the tape exits the frame 10 in substantially the same direction as it is being pulled; namely vertically toward the top of the wall.

When a sufficient length of joint compounded tape has been drawn from the roll 100, the tape may quickly be cut off at the trimmer 80. The container may be slid to the next location adjacent the wall and the next piece of tape may be drawn from the roll upwards toward the top of the wall.

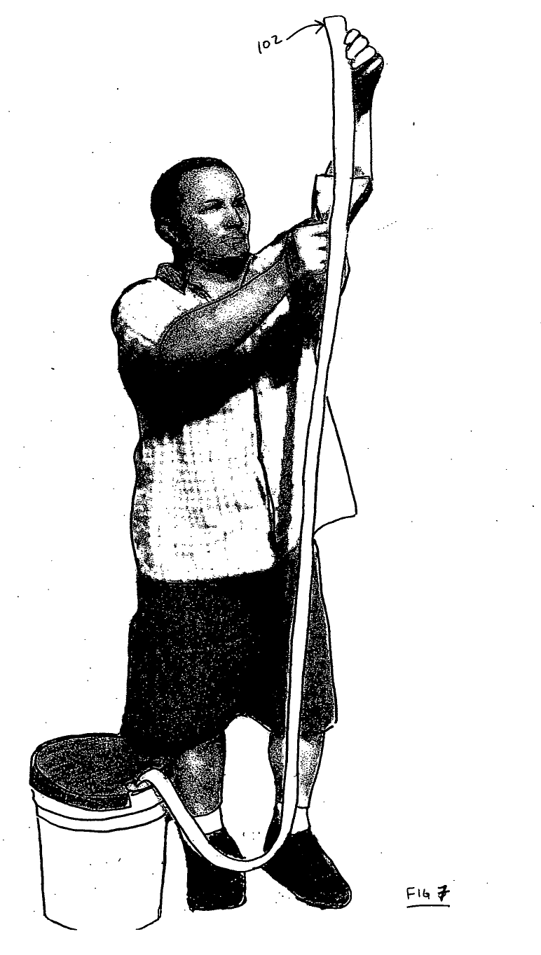

When the drywall tape roll 100 is emptied, the device 1 may be removed from the container such as by a handle 125 as shown in FIG. 6. The joint compound may run out the drain holes 49 and panel openings 25, 35. A new drywall tape roll 100 may be mounted onto the axle 50 and rethreaded.

In an alternate embodiment, the device 1 may sit completely within the standard five gallon container so that a lid may be placed on the container with the device 1 inside. In yet another embodiment, the frame 10 of the device 1 may sit completely inside the container while the extension arm 85 and trimmer 80 may extend above the top of the container for easier trimming of the tape. In embodiments where a portion of the device 1 or frame 10 extend above the container, it is preferable, but not essential that the portions extending above the container not interfere with the operation of the handle on the container.

As discussed previously, the specific dimensions provided in the embodiments described herein related to a device 1 suitable for use with a standard five-gallon container and up to a 500 foot roll of 2 inch wide drywall tape. It should be understood that dimensions of the frame 10 may be straightforwardly modified for rolls of wider drywall tape, multiple rolls of drywall tape, and smaller or larger containers.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

1. A drywall tape dispenser, comprising:
a frame having first and second frame sides and at least a first frame edge between the first and second frame sides, the first frame edge having a width;
an axle operatively connected to at least one of the first and second frame sides, the axle adapted to receive a roll of drywall tape;
a guide rod operatively connected to at least one of the first and second frame sides, the guide rod positioned below the axle,
a guide slot operatively connected to at least one of the first and second frame sides, the guide slot adapted to guide a length of drywall tape in a substantially vertical direction; and
a trimmer located downstream of the guide slot.

2. The dispenser of claim 1 wherein the first and second frame sides have a maximum length of 14 inches and a maximum height of 18 inches.

3. The dispenser of claim 2, wherein the width of the first frame edge is between approximately 2 inches and 3 inches.

4. The dispenser of claim 1 wherein the first and second frame sides have a maximum length that is less than the inside diameter of a standard five gallon container and a maximum height that is less than the inside height of a standard five gallon container.

5. The dispenser of claim 4 wherein the frame fits entirely inside a standard five gallon container.

6. The dispenser of claim 1, wherein the guide slot is integrally formed in the first frame edge.

7. The dispenser of claim 6, wherein the trimmer is a serrated trimmer.

8. The dispenser of claim 7, wherein the serrated trimmer is located at the end of an extension arm that extends from the first frame edge.

9. The dispenser of claim 1, wherein the guide rod is between approximately 4 inches and 8 inches below the axle.

10. The dispenser of claim 9, wherein the guide rod is positioned between the axle and the first frame edge.

11. The dispenser of claim 1, wherein the axle is removably operatively connected to at least one of the first and second frame sides.

12. A method of dispensing drywall tape, the method comprising the steps of:
providing a container suitable for holding drywall compound;
providing a drywall tape dispensing frame, the frame comprising;
first and second frame sides,
at least a first frame edge connecting the first and second frame sides, the first frame edge having a width of between approximately 2 inches and 3 inches;
an axle removably operatively connected to at least one of the first and second frame sides, the axle adapted to receive a roll of drywall tape;
a guide rod operatively connected to at least one of the first and second frame sides, the guide rod positioned below the axle; and
a guide slot operatively connected to at least one of the first and second frame sides, the guide slot adapted to direct drywall tape in a substantially upward direction;
providing a roll of drywall tape on the axle;
placing the drywall tape dispensing frame substantially in the container;
providing sufficient drywall compound in the container to cover the guide rod; and
drawing a length of tape from the roll of drywall tape, through the drywall compound, underneath the guide rod, and through the guide slot by pulling an end of the length of drywall tape.

13. The method of claim 12, wherein the step of drawing a length of tape from the roll of drywall tape, through the drywall compound, underneath the guide rod, and through the guide slot by pulling an end of the length of drywall tape includes pulling an end of the length of drywall tape in a substantially vertical direction.

14. The method of claim 12, wherein the step of placing the drywall tape dispensing frame substantially in the container includes placing the drywall tape dispensing frame entirely in the container.

15. The method of claim 14, wherein the frame further comprises:
a trimmer located downstream of the guide slot.

16. The method of claim 14, wherein the container is a standard five gallon container.

17. A drywall tape dispenser, comprising:
a frame having first and second frame sides and at least a first frame edge connecting the first and second frame sides, the frame adapted to fit substantially within a reservoir of joint compound;
an axle operatively connected to at least one of the first and second frame sides, the axle adapted to receive a roll of drywall tape;
a guide rod operatively connected to at least one of the first and second frame sides, the guide rod positioned below the axle, and
a guide slot operatively connected to at least one of the first and second frame sides, the guide slot adapted to guide a length of drywall tape in a substantially vertical direction.

18. The drywall tape dispense of claim 17, wherein the reservoir has a capacity of five gallons.

19. The drywall tape dispenser of claim 18, wherein the reservoir is a standard five gallon container.
